(19) United States
(12) Patent Application Publication
(10) Pub. No.: US 2008/0263489 A1
(43) Pub. Date: Oct. 23, 2008

(54) METHOD TO IDENTIFY AND GENERATE CRITICAL TIMING PATH TEST VECTORS

(76) Inventors: Miles G. Canada, Colchester, VT (US); Ian R. Govett, Richmond, VT (US); John Sargis, Essex, VT (US); Daryl M. Seitzer, Essex Junction, VT (US); Daneyand J. Singley, Williston, VT (US); Abhijeet R. Tanpure, Essex Junction, VT (US); Manikandan Viswanath, South Burlington, VT (US)

Correspondence Address: FREDERICK W. GIBB, III;Gibb & Rahman, LLC, 2568-A RIVA ROAD, SUITE 304, ANNAPOLIS, MD, 21401, US

(21) Appl. No.: 11/738,535

(22) Filed: Apr. 23, 2007

(51) Int. Cl. G06F 17/50

(52) U.S. Cl. 716/6

(57) ABSTRACT

A method of testing critical paths in integrated circuits begins by simulating at least one operation of an integrated circuit chip design to produce chip timing data. Next, critical paths of the integrated circuit chip design are identified based on the chip timing data. The method applies functional test signals to simulations of the critical paths and monitors the number of times each of the functional test signals propagate from the beginning to the end of each of the critical paths. This allows the method to identify stress producing test signals as those that propagate along the critical paths more than other test signals. These stress producing test signals are applied to integrated circuit chip hardware manufactured according to the integrated circuit chip design to stress test the hardware.

### BACKGROUND

1. Field of the Invention

The embodiments of the invention provide a method, program storage device, etc., to identify and generate critical timing path test vectors for integrated circuit devices.

2. Description of the Related Art

When manufacturing sophisticated devices, such as integrated circuits on chips, many factors in the design and manufacturing process can affect the performance and operability of the devices. One factor that has been found to play a role in high quality integrated circuit devices relates to the timing differences of communication and other signals as they travel across the circuits. Therefore, it is common to find and test the routes or “paths” within the circuit along which the various signals will travel to ensure that the most important paths or bottleneck paths (e.g., the critical paths) operate properly. Such critical paths are often tested by applying test pattern signals (test patterns) to the actual, physically manufactured circuit device, or by applying the test patterns to simulations of the circuit device.

Current methods of generating such test patterns can fail to account for timing sensitivities. To highlight critical paths in conventional systems, control bits are exercised to highlight the slowest delay paths. However, the process of identifying such critical (cycle time limiting) paths in hardware can be cumbersome. Some current methods require a series application of individual clock control bits to highlight the paths that fail.

For example, U.S. Pat. No. 6,453,437 to Kapur et al. (“Kapur '437”) discloses a method and system for performing transition fault simulation along lengthy circuit paths for automatic test pattern generation. Kapur '437 relates to test generation for defect driven fault coverage.

The steps in Kapur '437 include receiving and storing a netlist specification in a computer memory unit, and simulating the netlist using a computer implemented synthesis system. Using the netlist simulation, a set of circuit paths for each fault within the netlist specification is determined. From this set of paths, respective longest paths for each fault are found. Using an automatic test pattern generation (ATPG) process, a test vector is determined for a first fault. Transition fault simulation is then performed on the first fault by applying the test vector to a first path through the first fault, wherein the first path is the longest path traversing through the first fault as determined by the ATPG process. Responsive to the transition fault simulation, a second fault that is fortuitously detected by the test vector as applied to a second path traversing through the second fault is identified. The test vector is credited with detecting the first fault. Provided that the second path is the longest path that traverses through the second fault, the test vector is credited with detecting the second fault. If the second path is not the longest path, a test vector is generated in a subsequent iteration of the method to ensure that transition faults are detected along lengthy paths as opposed to short paths, thereby improving test quality.

Thus, as can be seen by the process disclosed in Kapur '437, the conventional systems utilize laborious methods of locating and testing critical paths. The embodiments disclosed below substantially improve the process of testing critical paths when compared to such conventional systems.

### SUMMARY

The embodiments of the invention provide a method, program storage device, service, system, etc., to identify and generate critical timing path test vectors used to test critical timing paths within integrated circuit devices. More specifically, the embodiments herein provide a method of testing critical paths in integrated circuits that begins by simulating at least one operation of an integrated circuit chip design to produce chip timing data. Next, critical paths of the integrated circuit chip design are identified based on the chip timing data. The identifying of the critical paths includes compiling the chip timing data and identifying timing paths that restrict an overall performance of the integrated chip. The method then applies functional test signals to simulations of the critical paths.

Following this, the number of times that each of the functional test signals propagate from a beginning to an end of each of the critical paths in a logic cone (portion of the circuit) is monitored. Stress producing test signals are identified as those that propagate along the critical paths more frequently than other test signals. This involves identifying on which critical paths the stress producing test signals travel. Subsequently, to stress test actual integrated circuit chip hardware, the stress producing test signals are applied to actual integrated circuit chip hardware manufactured according to the integrated circuit design that was simulated above.

Physical latches within the integrated circuit chip hardware are correlated to logic latches within the simulated critical paths of the integrated circuit chip. The method can determine such physical locations of the physical latches using a number of methods, such as referring to a previously created physical/logical latch correspondence file. Physical failure locations of the actual integrated circuit chip hardware are identified based on the results of the stress testing and the determination of the physical locations of the latches. Additionally, the number of times that each test signal propagates from the beginning to the end of each critical path is recorded in a database; and, the database can be queried to determine which of the functional test signals propagate along the critical paths more frequently than other test signals.

Accordingly, the embodiments of the invention help reduce tester time when bringing up new designs and facilitate the integration of chip timing data into automated chip test pattern processes. The embodiments herein use critical timing path data for creating test patterns which directly address the frequency limiting portions of the circuits to improve the performance of each circuit design. Conventional processes of testing which use actual hardware are time consuming, so only a few samples can be tested with conventional methods. To the contrary, with the embodiments herein, simulation is used to identify which test signals cause the most stress on the critical paths, which is a faster process and more efficient than conventional methods.

These and other aspects of the embodiments of the invention will be better appreciated and understood when considered in conjunction with the following description and the accompanying drawings. It should be understood, however, that the following descriptions, while indicating preferred embodiments of the invention and numerous specific details thereof, are given by way of illustration and not of limitation. Many changes and modifications may be made within the scope of the embodiments of the invention without departing from the spirit thereof, and the embodiments of the invention include all such modifications.

### BRIEF DESCRIPTION OF THE DRAWINGS

The embodiments of the invention will be better understood from the following detailed description with reference to the drawings, in which:

FIG. 1 is a flow diagram illustrating a method to identify and generate critical timing path test vectors;

FIG. 2 is a static timing block diagram;

FIG. 3 is a diagram illustrating a critical path description file;

FIG. 4 is a simulation critical path detector block diagram;

FIG. 5 is a diagram illustrating a simulation code;

FIG. 6 is a diagram illustrating a test vector applied to a logical model;

FIG. 7 is a diagram illustrating another test vector applied to a logical model;

FIG. 8 is a diagram illustrating a query applied to a database;

FIG. 9 is a flow diagram illustrating a method of testing critical paths in integrated circuits; and

FIG. 10 is a diagram illustrating a program storage device to identify and generate critical timing path test vectors.

### DETAILED DESCRIPTION OF PREFERRED EMBODIMENTS

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the embodiments of the invention.

As discussed above, conventional methodologies present slow and cumbersome processes for identifying and testing critical paths in integrated circuit designs and chips. The embodiments herein address this issue in a process that filters out critical timing paths from a chip timing run. Corresponding source and sink latch points (beginnings and ends of signal paths) from the timing run are then mapped to a chip-level netlist to identify the critical paths. Additional correspondence points are found within each circuit with the help of a “Schematic vs. HDL” checker to identify the cone of logic (logic region) being exercised. Those ordinarily skilled in the art would recognize the usefulness of a hardware description language (HDL) and associated schematic testing programs as discussed, for example, in U.S. Patent Publication 2003/0188282, which is incorporated herein by reference. Test signal patterns are then generated to exercise each logic cone.

Thus, the embodiments of the invention perform a static chip timing analysis based on a simulation of the circuit design. Data derived from the timing analysis is utilized during hardware development to help highlight which logical paths are expected to be the critical logic paths. Benefits of the methods provided herein include reducing the amount of time needed to develop new circuit designs by efficiently using test patterns, and the identification and isolation of critical timing paths for different operating conditions with targeted test patterns. Other benefits include the creation of a more efficient platform for test pattern generation, and the creation of a better interlink between design and testing.

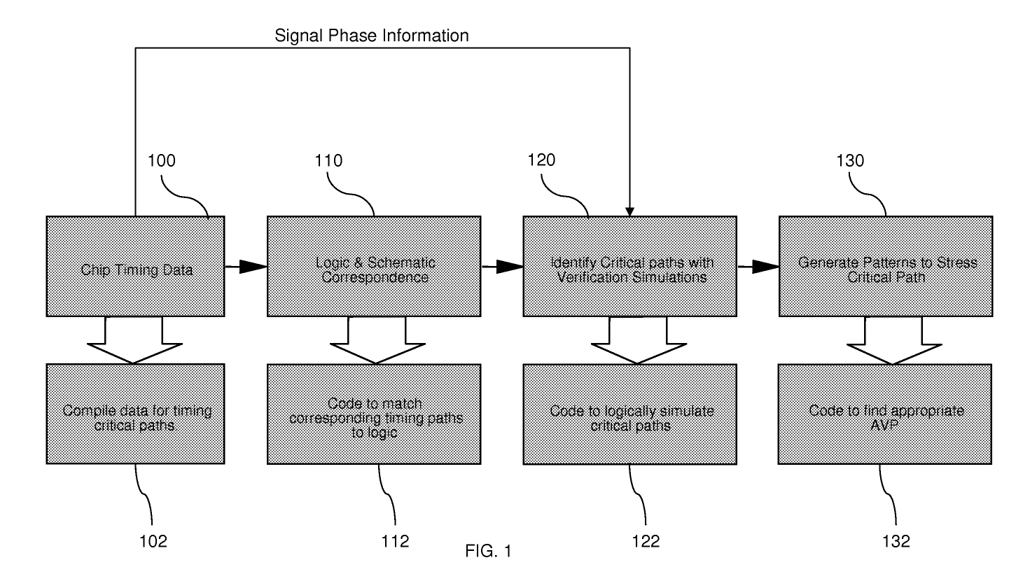

Referring to FIG. 1, one embodiment analyzes chip timing data to obtain signal phase information in item 100. This involves compiling data for determining the timing of the critical paths in item 102. In item 110, logic and schematic correspondence matching is performed, and more specifically, corresponding timing paths are matched to logic paths in item 112. In item 120, the method identifies critical paths with verification simulations. This involves, in item 122, logically simulating critical paths using the signal phase information obtained in item 100. The method generates test signal patterns to stress the critical paths in item 130. Specifically, appropriate architectural verification programs (AVPs) are run in item 132.

During chip timing, critical design paths are identified based on timing slack. In other words, those signal paths that are the “bottlenecks” are identified as the critical paths. For a complete discussion of timing analysis and timing slack see U.S. Patent Publication 2006/0112359, the complete disclosure of which is incorporated herein. For each signal path, a corresponding logic path is identified by observing the corresponding latch points and Boolean structure. Matching the timing path to the Boolean equation is done through any commonly available schematic-to-logic verification tool such as that disclosed in U.S. Patent Publication 2007/0050740, which is incorporated herein by reference. The resulting logic path is thus verified by this processing.

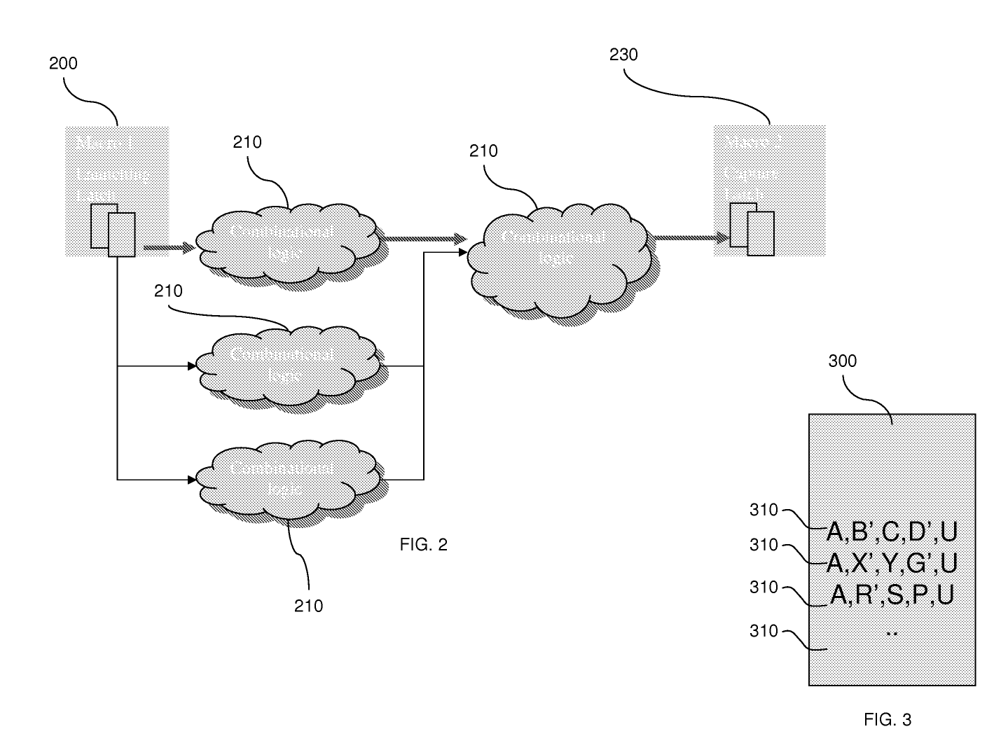

FIG. 2 illustrates a static timing block diagram. More specifically, a signal propagates from Macro 1 launching latch 200 and through one of a plurality of combinational logic components 210. The signal then propagates to Macro 2 capture latch 230. The structure shown in FIG. 2 comprises a verification simulation module that supports simulation based critical path detection and capture. Tests that are applied to the critical paths can then be used for verification purposes.

Referring now to FIG. 3, a simulation checker starts with a critical path description file 300 (each traced path includes a description file 300). Each line 310 in FIG. 3 is referred to as an event (or a sequential pipe stage) and all logical elements in each pipe stage need to be true to have correctly identified a path. The full signal names are listed in the description file 300 as well as their relative logic level (polarity).

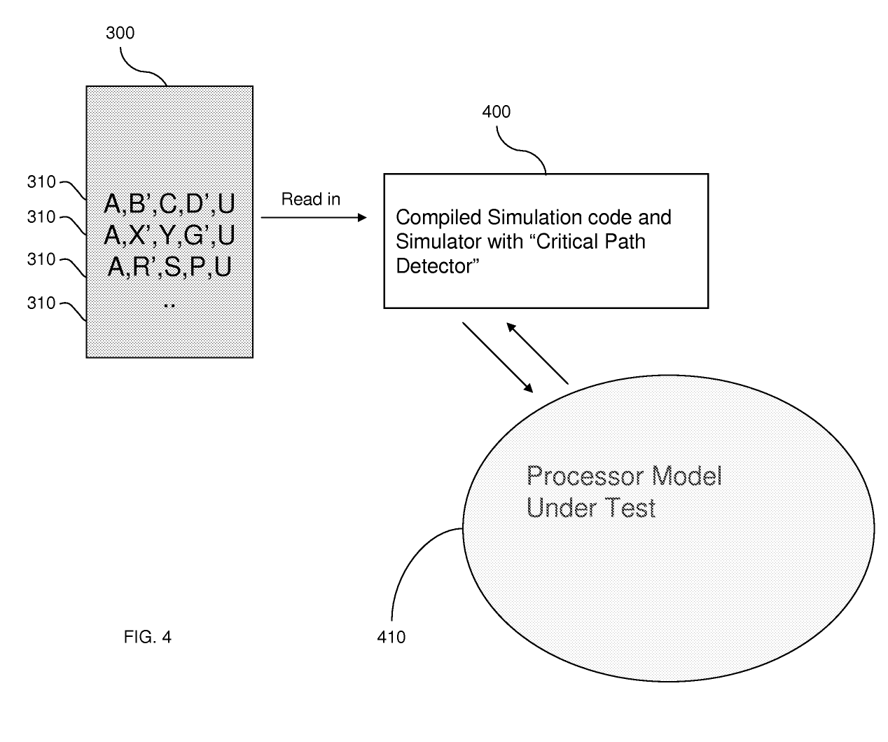

FIG. 4 illustrates a logic simulation critical path detector block diagram. A simulation code 400 imports the critical path description file 300. The simulation code 400 clocks and exercises the model 410 and checks each sequential critical path. If an entire critical path has been observed in proper form, then the simulation code 400 marks that critical path as being ready for testing.

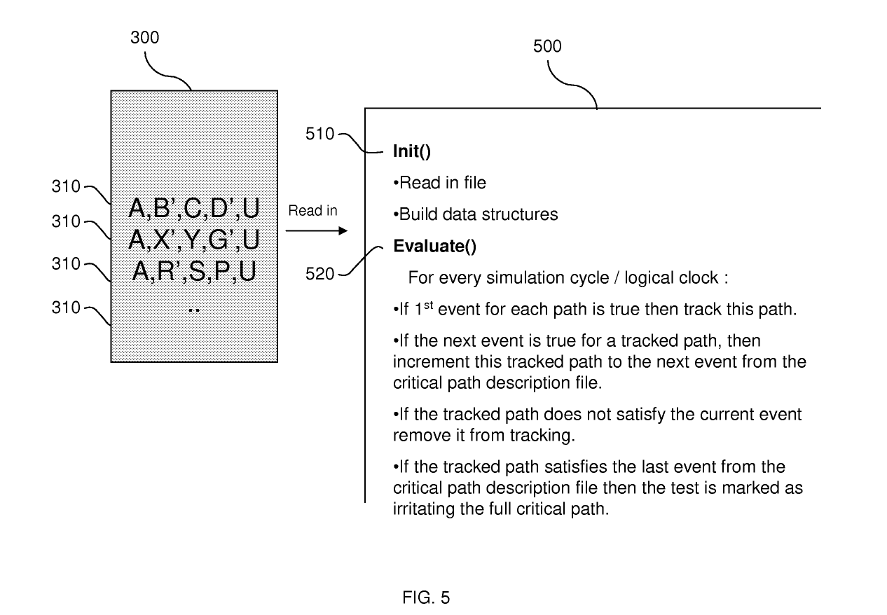

FIG. 5 illustrates an exemplary simulation code 500, which includes an init( ) section 510 that reads in the critical path description file 300, sets up the data structures, and finds each signal in the model. An evaluate( ) section 520 is also provided, which monitors the current cycle for a critical path and keeps track of where the simulation is located in the critical path.

During chip simulation, thousands of tests are run. For each test, the path monitor records the number of times a given test signal propagates down a given path (counts the number of times each path is hit by a test signal). When the test completes, the database is updated with the number of hits of different test signals for each path. At any time, the database can be queried for each path, wherein the database can identify the test which hits the path the most. One of the benefits of embodiments herein is that, once a test pattern that exercises a critical path most rigorously is identified, that test pattern can be converted to a manufacturing test pattern to be used to test the manufactured integrated circuit chip hardware. Thus, chip simulation and timing results can be leaveraged to automate the process of identifying those functional tests which exercise known critical paths the most and may be used later to test manufactured hardware.

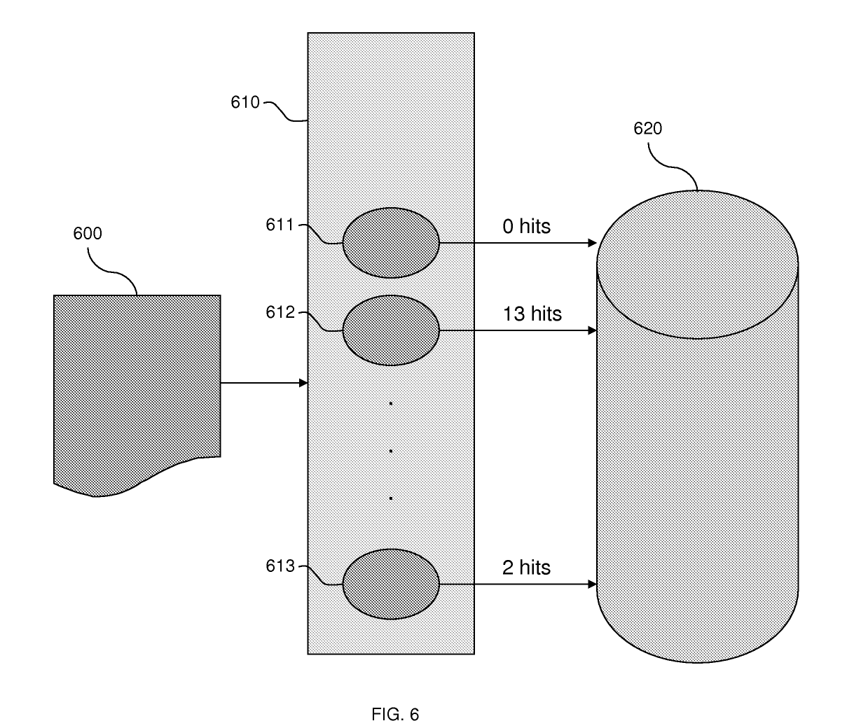

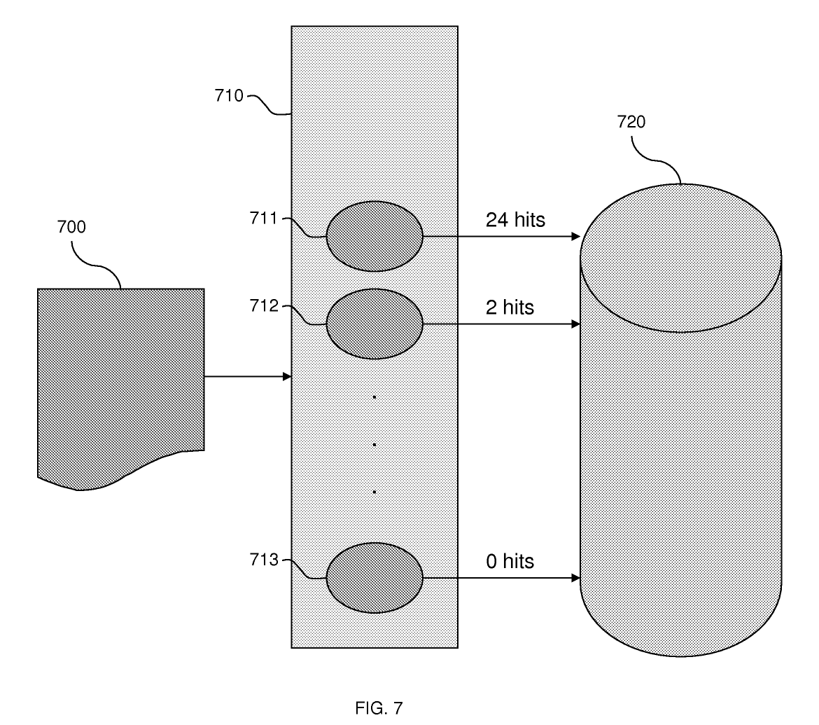

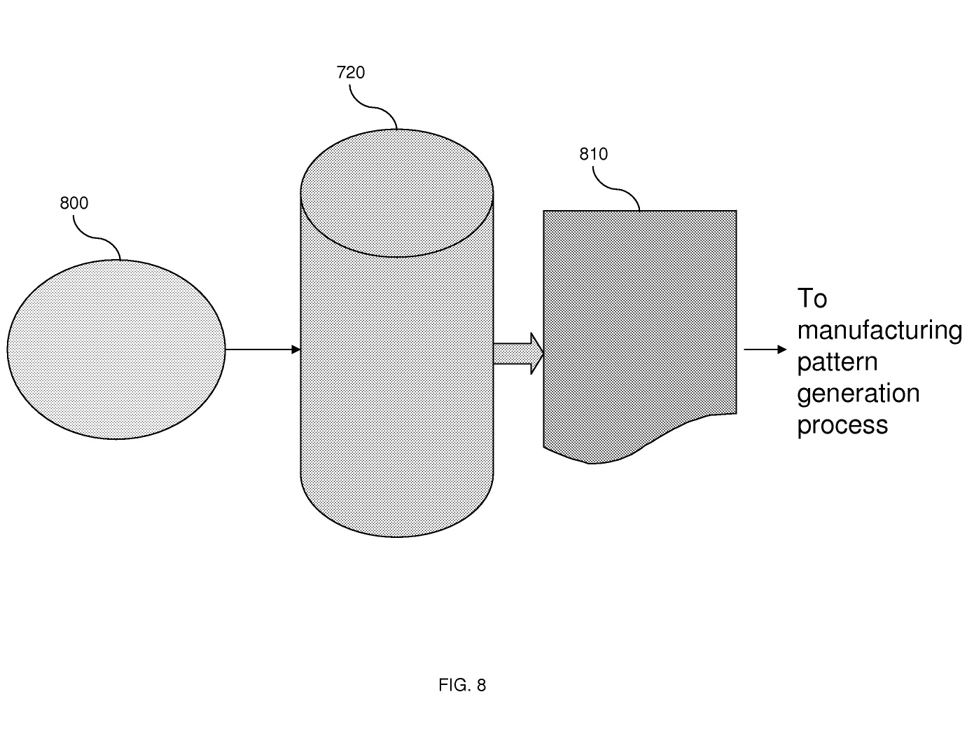

For example, FIG. 6 illustrates an add_store.tst test vector 600 being applied to a logical model 610 during a simulation. In FIG. 6, PM1 611, PM2 612, and PMn 613 represent individual critical timing paths identified in FIG. 3. During the simulation, a database 620 records no stimulus (0 hits) for the critical timing path 611, 13 instances (13 hits) where critical timing path 612 was simulated, and 2 instances (2 hits) where critical timing path 613 was simulated. The simulation in FIG. 7 utilizes a different test vector. Specifically, a mult_intr.tst test vector 700 is applied to a logical model 710. During the simulation, a database 720 records 24 instances (24 hits) where critical timing path 711 was simulated, 2 instances (2 hits) where critical timing path 712 was simulated, and no stimulus (0 hits) for critical timing path 713. After test vectors have been applied to the logical model via simulation, queries can be made to the database to retrieve the test vectors. Specifically, as illustrated in FIG. 8, a query 800 can be made to the database 720 to retrieve the test vector or test vectors 810 which stimulated each critical path identified in FIG. 3 the greatest number of times.

Thus, the embodiments of the invention perform a static chip timing analysis on a simulation of a circuit design. Data derived from the timing analysis is utilized during hardware development to help highlight which logical paths are expected to be the critical logic paths. The method also discovers and tracks critical logic paths (based on Boolean data) and harvests manufacturing test patterns from a database of tracked critical logic path tests. This reduces the amount of time needed to develop new circuit designs by efficiently using test patterns, and provides identification and isolation of critical timing paths for different operating conditions with targeted test patterns. Other benefits include the creation of a more efficient platform for test pattern generation, and the creation of a better interlink between design and testing.

In embodiments herein, a cone of logic is evaluated for an architectural state which asserts identified critical paths. For each identified critical path, an architectural state is abstracted to logical instruction streams. These instruction streams are possible candidates at the chip hierarchy to exercise a critical path. Matching of schematic and logic latch points is accomplished through schematic verification against the design logic. By finding start and end point latches, a particular logic path can be identified from the chip timing data.

For each path, instruction stream candidates are assembled into a suite of tests. These test signals are applied to the simulated integrated circuit design model. The path in the model is monitored for the number of times it is asserted. After all tests have been simulated on the chip model, the tests which stress the path the most are converted to hardware functional patterns. The hardware functional patterns can then be run “at speed” on actual manufactured hardware.

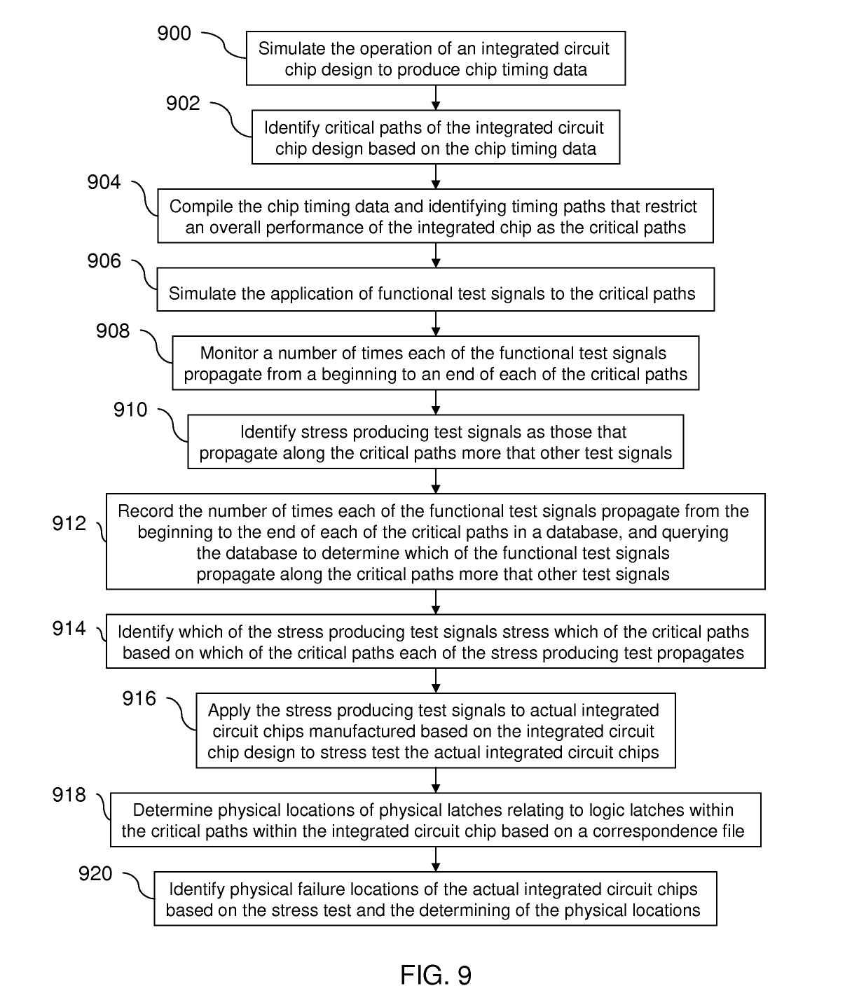

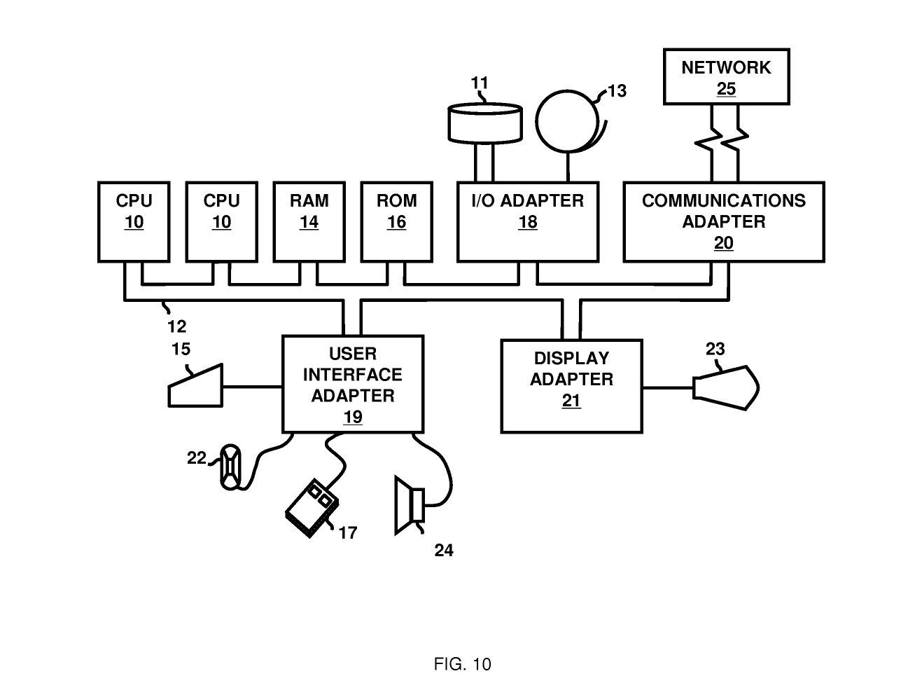

FIG. 9 is a diagram illustrating the forgoing method in flowchart form. The method begins in item 900 by simulating at least one operation of an integrated circuit chip design to produce chip timing data. In item 910, critical paths of the integrated circuit chip design are identified based on the chip timing data. This involves, in item 912, compiling the chip timing data and identifying the timing paths that restrict the overall performance of the integrated chip. The chip timing data is analyzed to obtain signal phase information, wherein data is compiled for timing critical paths. In item 920, the method applies functional test signals to simulations of the critical paths, which involves logically simulating critical paths using the signal phase information obtained while analyzing chip timing data.

The number of times each of the functional test signals propagate from a beginning to an end of each of the critical paths is monitored in item 930. In item 940, stress producing test signals are identified as those that propagate along the critical paths more frequently than other test signals. In item 941, the number of times each of the functional test signals propagate from the beginning to the end of each of the critical paths is recorded in a database. Further, (in item 941) when each test is completed, the database is updated with the number of times each of the different test signals travel along (e.g., hits or exercises) each of the different paths. In item 942, the method identifies on which critical paths each of the stress producing test signals propagate. As discussed above, for each path, the instruction stream candidates are assembled into a suite of tests. These tests are simulated on the integrated circuit model. Each path in the model is monitored for the number of times it is asserted during the simulation. After all tests have been simulated on the chip design model, the tests which stress the path the most frequently are converted to hardware functional patterns that are applied to actually manufactured integrated circuit chip hardware.

In item 950, to stress test the actual integrated circuit chip hardware, the stress producing test signals are applied to the actual integrated circuit chip hardware after it is manufactured according to the integrated circuit design that was simulated. Physical latches within said integrated circuit chip hardware relating to logic latches within the critical paths of the integrated circuit chip design are identified in item 960 using, for example, a logical-physical latch correspondence file. Additionally, in item 970, physical failure locations of the actual integrated circuit chip hardware are identified based on the stress test and the identified physical locations. As discussed above, correspondence from the timing path to the Boolean equation is done through a schematic-to-logic verification tool.

The embodiments of the invention can take the form of an entirely hardware embodiment, an entirely software embodiment, or an embodiment including both hardware and software elements. In a preferred embodiment, the invention is implemented in software, which includes, but is not limited to, firmware, resident software, microcode, etc. Furthermore, the embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by, or in connection with, the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments of the invention is depicted in FIG. 10. This schematic drawing illustrates a hardware configuration of an information handling/computer system in accordance with the embodiments of the invention. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

Accordingly, the embodiments of the invention help reduce tester time when bringing up new designs and facilitate the integration of chip timing data into automated chip test pattern processes. The embodiments herein use critical timing path data for creating test patterns which directly address the frequency limiting portions of the circuits to improve performance of each circuit design. Conventional processes of testing which use actual hardware are time consuming, so only a few samples can be tested with conventional methods. To the contrary, with the embodiments herein, simulation is used to identify which test signals cause the most stress on the critical paths, which is a faster process and more efficient than conventional methods.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments of the invention have been described in terms of preferred embodiments, those skilled in the art will recognize that the embodiments of the invention can be practiced with modification within the spirit and scope of the appended claims.

What is claimed is:

1. A method of testing critical paths in integrated circuits comprising:
simulating at least one operation of an integrated circuit chip design to produce chip timing data;
identifying critical paths of said integrated circuit chip design based on said chip timing data;
applying test signals to simulations of said critical paths;
monitoring a number of times each of said test signals propagates from a beginning to an end of each of said critical paths;
identifying stress producing test signals as those that propagate along said critical paths more than other test signals; and
applying said stress producing test signals to integrated circuit chip hardware manufactured according to said integrated circuit chip design.

2. The method according to claim 1, further comprising determining physical locations of latches within said integrated circuit chip hardware relating to logic latches within said critical paths of said integrated circuit chip design.

3. The method according to claim 2, further comprising identifying physical failure locations of said integrated circuit chip hardware based on results of said applying of said stress producing test signals and said determining of said physical locations of said latches.

4. The method according to claim 1, further comprising identifying on which of said critical paths each of said stress producing test signals propagate.

5. The method according to claim 1, wherein said identifying of said critical paths comprises compiling said chip timing data and identifying timing paths that restrict an overall performance of said integrated chip as said critical paths.

6. The method according to claim 1, further comprising recording said number of times each of said test signals propagate from said beginning to said end of each of said critical paths in a database, and querying said database to determine which of said test signals propagate along said critical paths more than other test signals.

7. A method of testing critical paths in integrated circuits comprising:
simulating at least one operation of an integrated circuit chip design to produce chip timing data;
identifying critical paths of said integrated circuit chip design based on said chip timing data;
applying test signals to simulations of said critical paths;
monitoring a number of times each of said test signals propagate from a beginning to an end of each of said critical paths;
identifying stress producing test signals as those that propagate along said critical paths more than other test signals;
applying said stress producing test signals to integrated circuit chip hardware manufactured according to said integrated circuit chip design; and
identifying physical failure locations of said integrated circuit chip hardware based on results of said applying of said stress producing test signals.

8. The method according to claim 7, further comprising determining physical locations of latches within said integrated circuit chip hardware relating to logic latches within said critical paths of said integrated circuit chip hardware.

9. The method according to claim 7, further comprising identifying on which of said critical paths said stress producing test signals propagate.

10. The method according to claim 7, wherein said identifying of said critical paths comprises compiling said chip timing data and identifying timing paths that restrict an overall performance of said integrated chip as said critical paths.

11. The method according to claim 7, further comprising recording said number of times each of said test signals propagate from said beginning to said end of each of said critical paths in a database, and querying said database to determine which of said test signals propagate along said critical paths more than other test signals.

12. A method of testing critical paths in integrated circuits comprising:
simulating at least one operation of an integrated circuit chip design to produce chip timing data;
identifying critical paths of said integrated circuit chip design based on said chip timing data, comprising compiling said chip timing data and identifying timing paths that restrict an overall performance of said integrated chip as said critical paths;
applying test signals to simulations of said critical paths;
monitoring a number of times each of said test signals propagate from a beginning to an end of each of said critical paths;
identifying stress producing test signals as those that propagate along said critical paths more than other test signals;
applying said stress producing test signals to integrated circuit chip hardware manufactured according to said integrated circuit chip design;
determining physical locations of latches within said integrated circuit chip hardware relating to logic latches within said critical paths of said integrated circuit chip design;
identifying physical failure locations of said integrated circuit chip hardware based on results of said applying of said stress producing signals and said determining of said physical locations.

13. The method according to claim 12, further comprising identifying on which of said critical paths each of said stress producing test signals propagate.

14. The method according to claim 12, further comprising recording said number of times each of said test signals propagate from said beginning to said end of each of said critical paths in a database, and querying said database to determine which of said test signals propagate along said critical paths more than other test signals.

15. A program storage device readable by machine, tangibly embodying a program of instructions executable by the machine to perform a method of testing critical paths in integrated circuits comprising:
simulating at least one operation of an integrated circuit chip design to produce chip timing data;
identifying critical paths of said integrated circuit chip design based on said chip timing data;
applying test signals to simulations of said critical paths;
monitoring a number of times each of said test signals propagate from a beginning to an end of each of said critical paths;
identifying stress producing test signals as those that propagate along said critical paths more than other test signals; and
applying said stress producing test signals to integrated circuit chip hardware manufactured according to said integrated circuit chip design.

16. The program storage device according to claim 15, further comprising determining physical locations of latches within said integrated circuit chip hardware relating to logic latches within said critical paths of said integrated circuit chip design.

17. The program storage device according to claim 16, further comprising identifying physical failure locations of said integrated circuit chip hardware based on results of said applying of said stress producing test signals and said determining of said physical locations.

18. The program storage device according to claim 15, further comprising identifying on which of said critical paths each of said stress producing test signals propagate.

19. The program storage device according to claim 15, wherein said identifying of said critical paths comprises compiling said chip timing data and identifying timing paths that restrict an overall performance of said integrated chip as said critical paths.

20. The program storage device according to claim 15, further comprising recording said number of times each of said test signals propagate from said beginning to said end of each of said critical paths in a database, and querying said database to determine which of said test signals propagate along said critical paths more than other test signals.
